(19) United States
(12) Patent Application Publication
(10) Pub. No.: US 2009/0320264 A1
(43) Pub. Date: Dec. 31, 2009

(54) DISPOSABLE KEG WITH A DISPOSABLE FITTING AND METHOD OF MAKING SAME, WHICH KEG IS CONFIGURED TO CONTAIN A BEVERAGE SUCH AS MINERAL WATER, TABLE WATER, BEER, OR A SIMILAR BEVERAGE, THE FITTING BEING HELD ONTO A NECK OF THE KEG BY WELDING OR BY DEFORMATION OF A SHRINKABLE SLEEVE

(76) Inventors: Thomas BERGER, Glashutten (DE); Gerhard KUNZ, Bingen (DE); Christian BOLSCHER, Wiesbaden (DE); Thorsten SCHMIDT, Worms (DE); Robert DAVID, Wiesbaden (DE); Jurgen LANDAUER, Ober-Ramstadt (DE)

Correspondence Address: NILS H. LJUNGMAN & ASSOCIATES, P. O. BOX 130, GREENSBURG, PA, 15601-0130, US

(21) Appl. No.: 12/487,783

(22) Filed: Jun. 19, 2009

Related U.S. Application Data
(63) Continuation-in-part of application No. PCT/EP2007/009692, filed on Nov. 8, 2007.

(30) Foreign Application Priority Data
Dec. 22, 2006 (DE) 10 2006 061 120.9

(51) Int. Cl. B23P 11/00; B32B 37/02

(52) U.S. Cl. 29/428; 156/86

(57) ABSTRACT

A disposable keg with a disposable fitting and method of making same, which keg is configured to contain a beverage such as mineral water, table water, beer, or a similar beverage, the fitting being held onto a neck of the keg by welding or by deformation of a shrinkable sleeve. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2007/009692, filed on Nov. 8, 2007, which claims priority from Federal Republic of Germany Patent Application No. 10 2006 061 120.9, filed on Dec. 22, 2006. International Patent Application No. PCT/EP2007/009692 was pending as of the filing date of this application. The United States was an elected state in International Patent Application No. PCT/EP2007/009692.

### BACKGROUND

1. Technical Field

The present application relates to a disposable keg with a disposable fitting and method of making same, which keg is configured to contain a beverage such as mineral water, table water, beer, or a similar beverage, the fitting being held onto a neck of the keg by welding or by deformation of a shrinkable sleeve.

2. Background Information

Background information is for informational purposes only and does not necessarily admit that subsequently mentioned information and publications are prior art.

The present application relates to a disposable keg with a disposable fitting and method of making same, which keg is configured to contain a beverage such as mineral water, table water, beer, or a similar beverage, the fitting being held onto a neck of the keg by welding or by deformation of a shrinkable sleeve. In an embodiment, the keg may be made essentially of plastic. In another possible embodiment the keg body may be fabricated from PET and have a keg fitting on a mouth area that forms a keg opening.

Some non-returnable kegs comprise a metal barrel or keg body, which forms the interior of the keg which holds a liquid, and a non-returnable keg fitting, which is inserted in a sealed manner into the interior of the keg with a plug-like fitting element in an opening in a curved bottom of the keg body, where it is fastened using a clamping ring or by a locking mechanism.

Some bag-in-box containers comprise an external housing and an internal bag or tube that forms the interior of the container to hold the liquid. In these bag-in-box containers, the connection of these inner bags are made of plastic with a tap or fitting element that forms the dispensing opening of the bag-in-box container by welding.

### OBJECT OR OBJECTS

An object of the present application is to create a keg which can be manufactured economically in the form of a non-returnable keg and can also be disposed of or recycled easily after use.

Another object of the present application is a keg (disposable or non-returnable keg) which comprises plastic, in one possible embodiment from a keg body made of PET and a non-returnable keg fitting on a keg neck, which forms a keg opening and is manufactured in one piece with the keg body.

An object of the present application is to create a keg which can be manufactured economically in the form of a non-returnable keg and can also be disposed of or recycled easily after use.

### SUMMARY

To accomplish this object, the present application teaches a keg made essentially of plastic, in one possible embodiment with a keg body fabricated from PET, and a keg fitting on a mouth area that forms a keg opening. The fitting, realized in the form of a non-returnable fitting, is held on the mouth area non-positively and/or positively.

The keg fitting is held on the keg neck non-positively or positively by welding or by deformation of a wall segment or tube that surrounds the keg neck by the application of heat.

The present application teaches that this object can be optimally accomplished by a keg comprising a keg body made of plastic, in one possible embodiment of PET, and of a keg neck which is realized in the form of a non-returnable keg fitting on a keg opening and is manufactured in one piece with the keg body, and the keg fitting is non-positively or positively held onto the keg neck by welding or by deformation of a wall segment or tube that surrounds the keg neck under the application of heat, and in one possible embodiment also on account of the fact that without the use of additional materials that increase the costs of manufacture and of recycling, the connection of the keg fitting and/or of the fitting element which is also manufactured out of plastic, is achieved by welding or by deformation of the wall segment that surrounds the keg neck or is provided on or is molded on the keg fitting or on the fitting element.

The term “keg” means a container that is designed to hold a liquid, in one possible embodiment a beverage, in which the interior of the container which is occupied by the liquid is bounded by the wall of the keg body. “Keg neck” as used in this application means the neck-like projection that defines the keg opening and on which the keg fitting that seals the interior of the keg is connected in a sealed manner.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Developments are described according to the present application. The present application is explained in the following with reference to the accompanying drawing figures of embodiments of the present application. There is shown in:

FIG. 1 shows one possible embodiment of the disposable keg with a disposable fitting, the opening structure of the keg has two flanges;

FIG. 2 shows another possible embodiment of the disposable keg with a disposable fitting, the opening structure of the keg has one flange;

FIG. 3 shows yet another possible embodiment of the disposable keg with a disposable fitting, the disposable fitting having a sleeve about an outer portion of the opening structure of the keg;

FIG. 4 shows a further possible embodiment of the disposable keg with a disposable fitting, the disposable fitting having a connecting segments configured to hold a flange about the opening structure of the keg;

FIG. 5 shows one possible embodiment of the disposable keg with a disposable fitting, the disposable fitting having flexible claws configured to grasp the opening structure of the keg;

FIG. 6 shows another possible embodiment of the disposable keg with a disposable fitting, the disposable fitting has a circular ring configured to grasp the opening structure of the disposable keg;

FIG. 7 shows yet another possible embodiment of the disposable keg with a disposable fitting, the disposable fitting has a connecting piece, essentially in the shape of a circular cylinder, configured to connect with in inner portion of the opening structure of the keg;

FIG. 8 shows a further possible embodiment of the disposable keg with a disposable fitting, the disposable fitting has a sleeve configured to shrink and hold the disposable fitting on the keg;

FIG. 8A shows the embodiment of FIG. 8 with additional features described;

FIG. 8B shows another possible embodiment of the disposable keg with a disposable fitting, examples of types of fitting mechanisms are shown; and

FIG. 9 shows yet another possible embodiment of the disposable keg with a disposable fitting.

### DESCRIPTION OF EMBODIMENT OR EMBODIMENTS

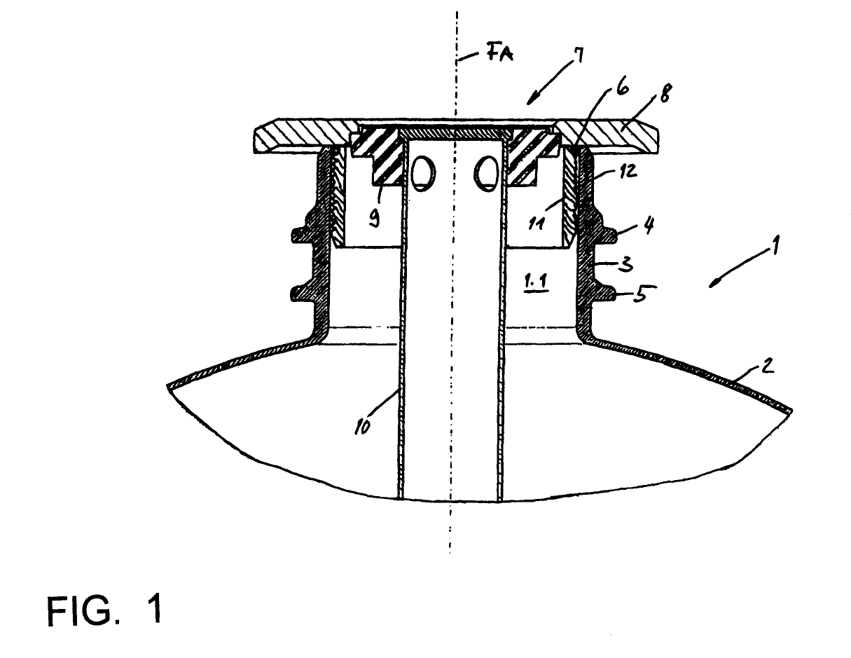

FIG. 1 shows a keg with a keg body 2 which is made of plastic or PET, which is also called the keg blank, and which has a shape that will be familiar to a technician skilled in the art, and in one possible embodiment with a molded keg neck 3. The keg neck 3 forms the mouth area of the keg 1 with the keg opening 1.1 and is provided on its external surface, for example, with two keg rings 4 and 5 that surround the keg axis concentrically and project radially.

Fastened in a sealed manner to the keg neck 3, using at least one seal 6, is the non-returnable fitting 7, which has the valve or functional elements necessary and/or desired for the filling of the keg 1 with the liquid being packaged and for the dispensing of the liquid from the keg 1, and in the illustrated embodiment comprises, among other things, the top flange-like fitting element (also the cap) illustrated in FIG. 1, with which the non-returnable fitting is fastened to the keg neck 3 and on which additional functional elements of the non-returnable fitting 7 identified as 9 and 10 in FIG. 1 are provided. The fitting element lies with its upper disc-like segment in FIG. 1 against the opening edge of the keg opening 1.1 and projects beyond its external surface in a flange-like fashion for the protection of the keg neck 3, among other things.

The non-returnable fitting 7 in the possible embodiment illustrated in FIG. 1 is connected essentially non-positively with the keg 1. For this purpose, the fitting element 8 is realized in one piece with a cylindrical circular connecting segment 11 which surrounds the fitting axis FA concentrically and extends with the press fit into the keg opening 1.1 which is also in the shape of a circular cylinder. On its outside surface, the connection segment 11 is provided with a plurality of claws, for example in the form of projections 12 that concentrically surround the axis of the keg 1. These projections are each realized in the form of barbs so that they allow the connecting segment 11 to be pushed into the circular cylindrical keg opening 1.1, but counteract the removal of the connecting segment 11 from the keg opening 1.1 because of the barbs that have clawed into the interior surface of the keg neck 3.

To achieve, in one possible embodiment, a reliable or substantially reliable connection between the keg 1 and the non-returnable fitting 7, in addition to this connection by the projections 11 which is partly non-positive but also partly positive or form-fitting (as a result of the engagement of the projections 12 into the material of the keg neck), an additional non-positive connection is achieved by means of a suitable adhesive technology and/or by means of an additional welding of the connecting segment 11 to the keg neck 3, e.g. using an induction welding process, an ultrasound welding process, etc.

The non-returnable fitting 7 in the possible embodiment illustrated in FIG. 1 is connected essentially non-positively with the keg 1. For this purpose, the fitting element 8 is realized in one piece with a connecting segment 11 in the shape of a circular cylinder which surrounds the fitting axis FA concentrically and extends with the press fit into the keg opening 1.1 which is also in the shape of a circular cylinder. On its outside surface, the connection segment 11 is provided with a plurality of claws, for example in the form of projections 12 that concentrically surround the axis of the keg 1. These projections are each realized in the form of barbs so that they allow the connecting segment 11 to be pushed into the circular cylindrical keg opening 1.1, but counteract the removal of the connecting segment 11 from the keg opening 1.1 because of the barbs that have clawed into the interior surface of the keg neck 3.

To achieve a particularly reliable connection between the keg 1 and the non-returnable fitting 7, in addition to this connection by the projections 11 which is partly non-positive but also partly positive or form-fitting (as a result of the engagement of the projections 12 into the material of the keg neck), an additional non-positive connection is achieved by means of a suitable adhesive technology and/or by means of an additional welding of the connecting segment 11 to the keg neck 3, e.g. using an induction welding process, an ultrasound welding process, etc.

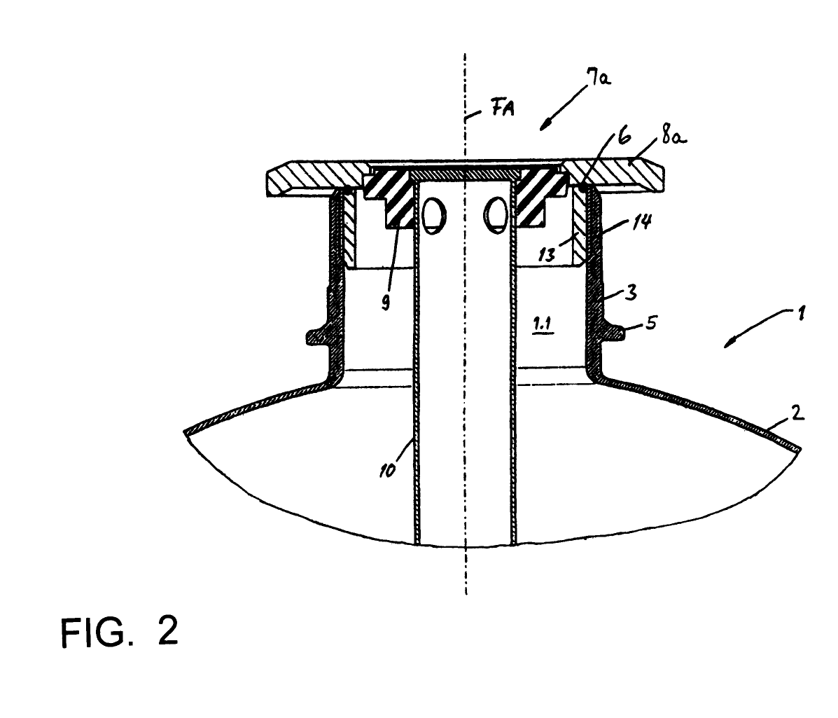

FIG. 2 shows, in an additional possible embodiment, the keg 1 with a keg fitting 7a which differs from the keg fitting 7 essentially in that the connecting segment 13 of the fitting element 8a which extends into the keg opening 1.1 is provided on its external periphery with a male thread by means of which the non-returnable fitting 7a is screwed into a female thread 14 of the keg neck 3.

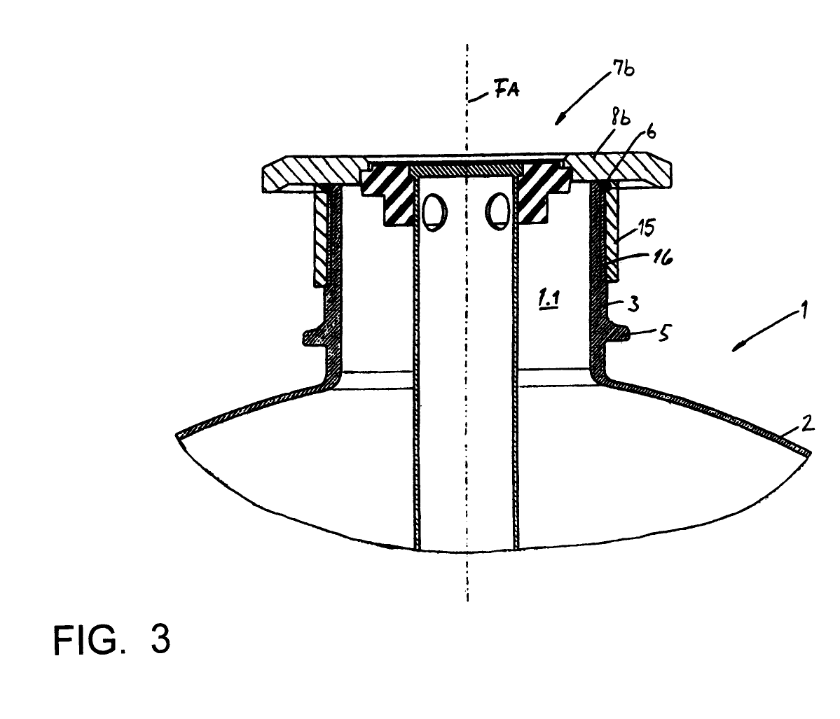

FIG. 3 shows, in the form of an additional possible embodiment, the keg 1 together with a non-returnable fitting 7b which differs from the non-returnable fitting 7 in that molded onto the fitting element 8b is a cylindrical connecting segment 15 which grips the fitting neck or keg neck 3 on its exterior surface and is provided with a female thread with which the non-returnable fitting 7b is screwed onto a male thread 16 which is provided on the exterior surface of the keg neck 3 in the vicinity of the opening edge of the keg mouth 1.1.

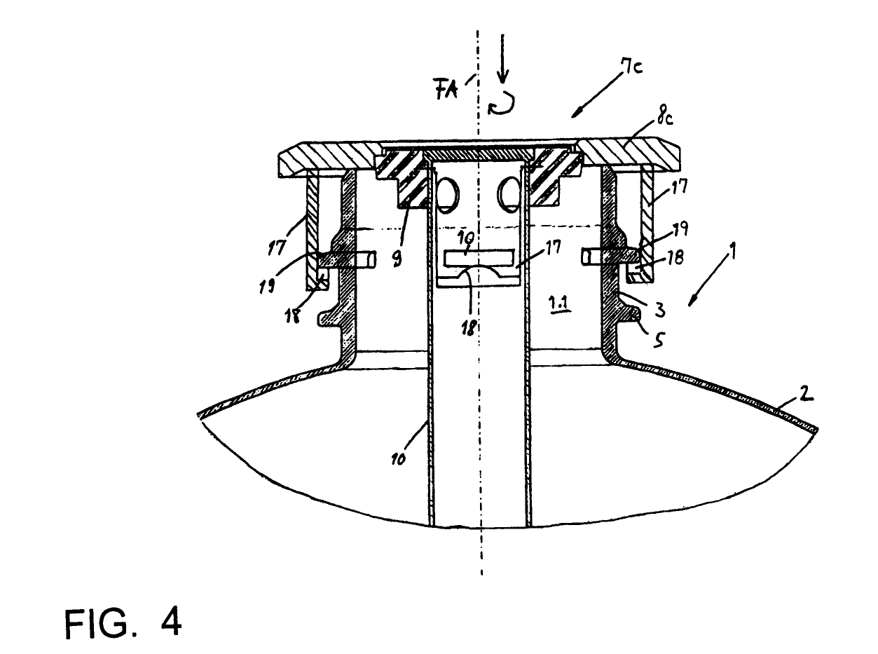

FIG. 4 shows the keg 1 together with a non-returnable fitting 7c which is held positively or in a form-fitting manner on the keg neck 3 by a plurality of wall or connecting segments 17 which are molded onto the upper disc-shaped segment of the fitting element 8c which projects beyond the peripheral surface of the keg neck 4 and are distributed around the axis FA of the non-returnable fitting 7c, form segments of a circular cylinder that concentrically surrounds the axis FA and are provided in the vicinity of their free end on the inside with an interlocking surface 18 which is convexly curved around axes that are radial or approximately radial to the axis FA.

In this possible embodiment, the neck ring 4 that sits on the mouth edge of the keg opening 11 is segmented, i.e. it forms a plurality of neck ring segments 19 that are distributed at uniform angular intervals around the axis FA and the number of which is equal to the number of connecting segments 17. For the fastening of the non-returnable fitting 7c, this fitting 7c is placed on the keg neck 3 so that each connecting segment 17 is initially located between two neck ring segments 19. Then, by rotating the non-returnable fitting 7c around the axis FA, a bayonet-like positive or form-fitting interlocking of the non-returnable fitting 7c on the keg 1 is achieved. Each connecting segment 17 thereby grips with its contact surface 17 a neck ring segment 19 from behind. The contact or interlocking surfaces 18 are each provided with a plurality of locks that act like barbs that claw onto the neck ring segments 19 by pressing into the material of these segments and thereby counteract an undesirable loosening of the bayonet connection between the non-returnable fitting 7c and the keg 1.

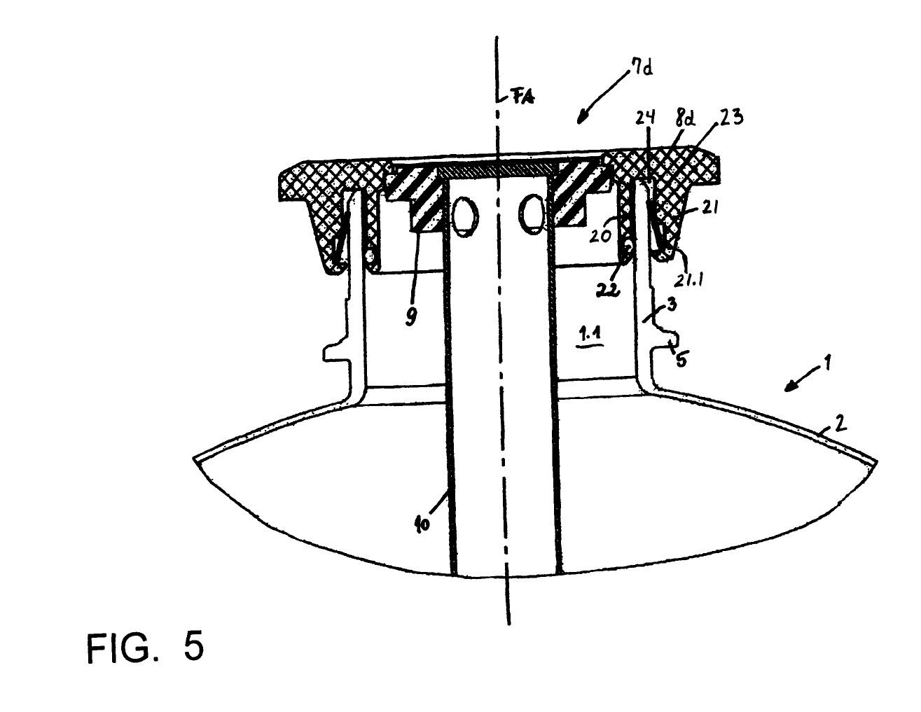

FIG. 5 shows the keg 1 together with a non-returnable fitting 7d in which the fitting element 8d is realized so that when the non-returnable fitting 7d is installed on the keg neck 3, it overlaps and grasps the keg neck 3 in the vicinity of the mouth opening on the inside and outside, each with a connecting segment 20 and 21 in the shape of a circular cylinder. The inward connecting segment 20 is thereby provided with a seal 22 that is pressed against the interior surface of the keg neck 3. The outboard connecting segment 21 has a plurality of flexible claws 23 distributed around the axis FA of the non-returnable fitting 7d which project with their free ends beyond the interior surface of the connecting segment 21 facing the keg neck 3 and act like barbs or claws to fix the fitting element 8d in position when it is placed on the keg neck 3. The claws 23 are made, for example of spring steel sheet and are supported with their lower end which lies farther from the mouth edge of the keg opening 1.1, i.e. the lower end in FIG. 5, in a recess 21.1 in the connecting segment 21, and project diagonally with their upper end illustrated in FIG. 5 into the ring-shaped opening 24 formed between the two connecting segments 20 and 21 and holding the keg neck 3. The claws 23 thereby enclose an angle on this end with the axis FA which opens toward the keg body 2. As a result of the claws or engagement of the claws 23 in the material of the keg neck 3, a secure positive and simultaneously or substantially simultaneously non-positive hold of the non-returnable fitting 7d on the keg neck 3 is achieved.

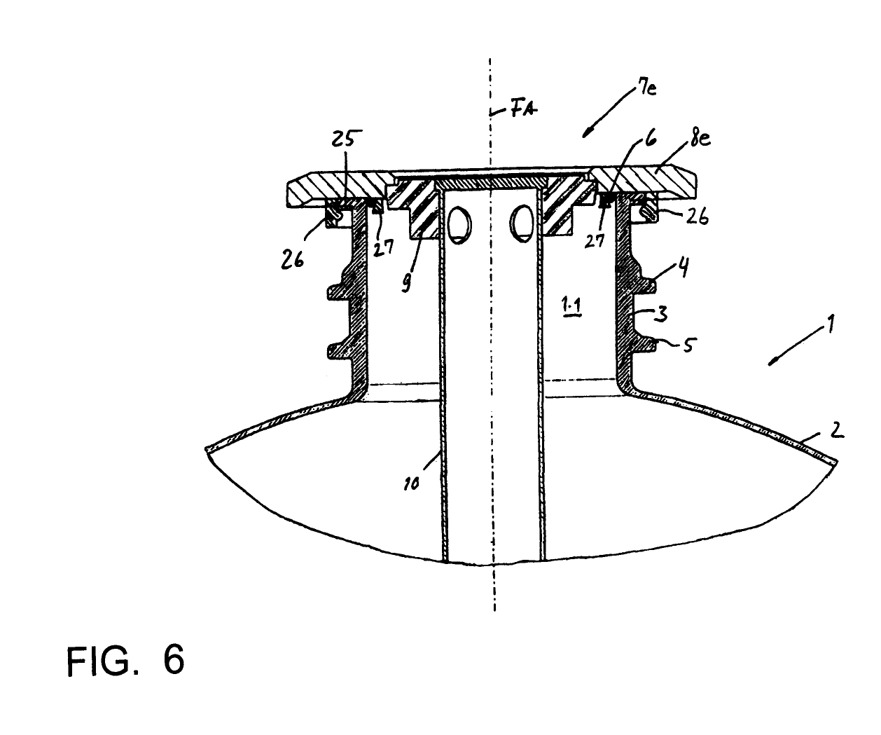

FIG. 6 shows the keg 1 together with a non-returnable fitting 7e which is held with its fitting element 8e by an encircling clamping or deformation on the keg neck 3. For this purpose, the keg neck 3 has, on the mouth edge of the keg opening 1.1, an outwardly projecting flange segment 25 which is gripped positively or in a form-fitting manner from behind by a connecting segment 26 in the shape of a circular ring which is molded on the fitting element 8e and projects beyond the underside of the fitting element 8e. In this embodiment, the seal 6 is located in the vicinity of the mouth edge of the keg opening 1.1 between the interior surface of the keg neck 3 and an additional connecting segment 27 in the shape of a circular ring that is molded on the fitting element 8e and also projects beyond the underside of this fitting element.

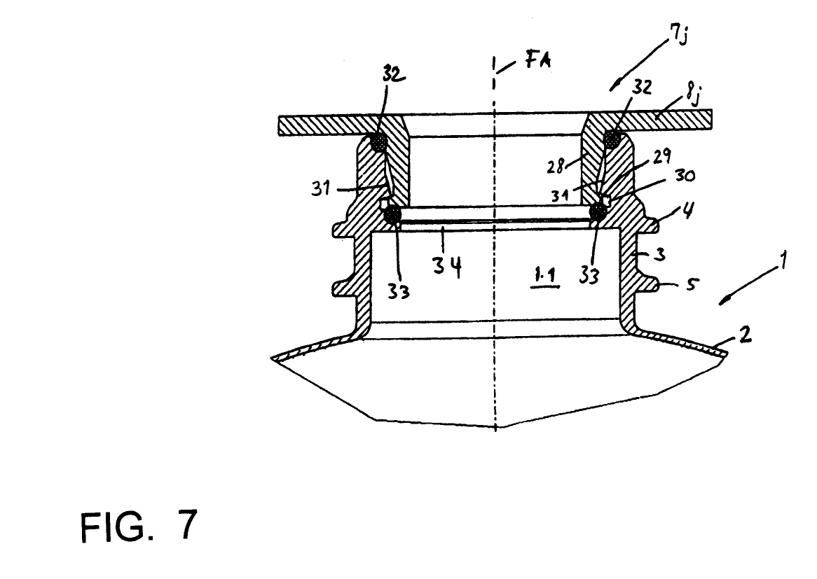

FIG. 7 shows the keg 1 together with a non-returnable fitting 7f, of which the fitting element 8f is shown. This fitting element 8f is held positively by locking on the keg neck 3, and in one possible embodiment by providing a connecting piece 28 which is essentially in the shape of a circular cylinder and which is introduced into the keg opening 1.1 on its free end with a ring-shaped projection 29 which forms a locking piece, which projection 29 concentrically surrounds the axis FA of the non-returnable fitting 7f or of the fitting element 8f. The projection 29 is engaged in an open annular groove 30 on the interior surface of the keg neck 3. To facilitate the locking of the projection 29 in the groove 30 during assembly, the interior surface of the keg neck 3 is realized so that it is slightly conical in an area 31 adjacent to the groove 30, so that the interior cross section of the conical opening 1.1 becomes somewhat wider toward its mouth edge.

For the sealing between the non-returnable fitting 7f and the keg 1, in this embodiment two sealing rings 32 and 33 are provided, each of which concentrically surrounds the axis FA and of which the one sealing ring 32 is provided on the mouth edge of the keg opening 1.1 between the keg neck 3 and the fitting element 8f. The other sealing ring 33 is supported axially on a ring-like projection 34 that projects into the keg opening 1.1 and is in contact against the free end of the connecting segment 28.

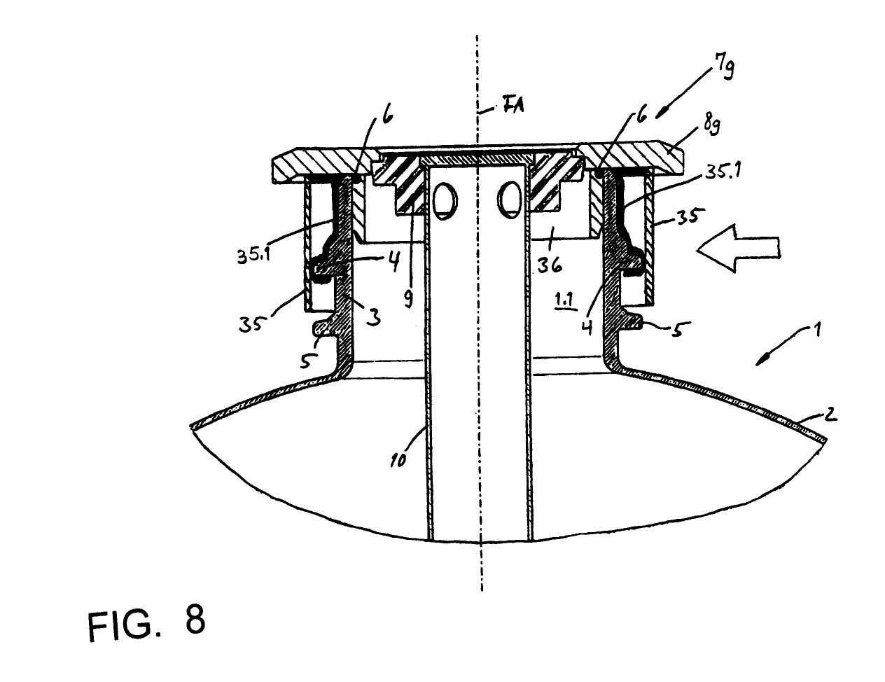

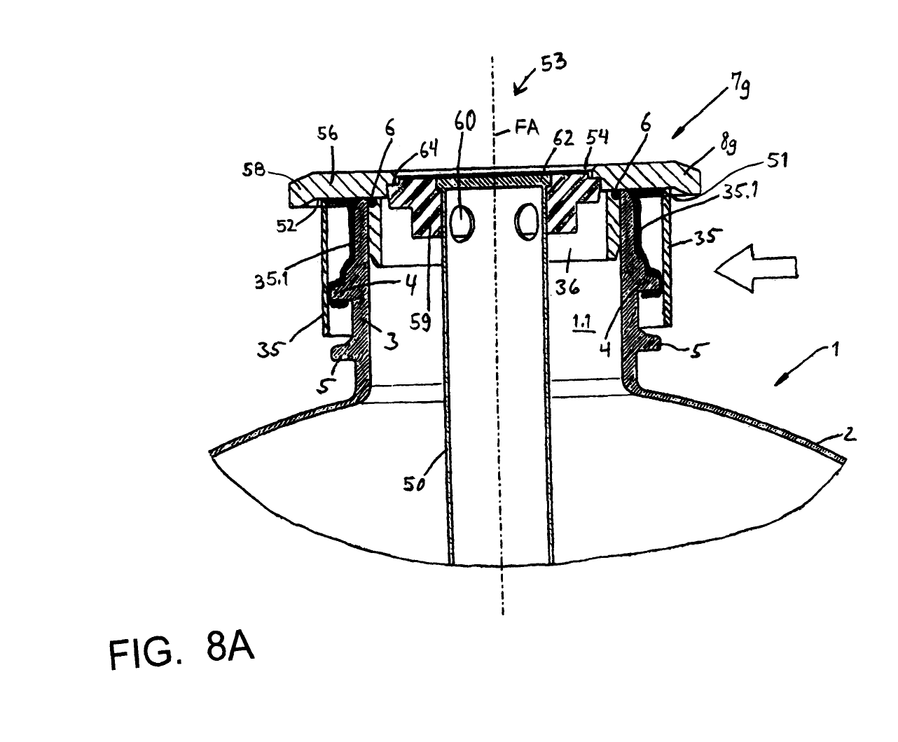

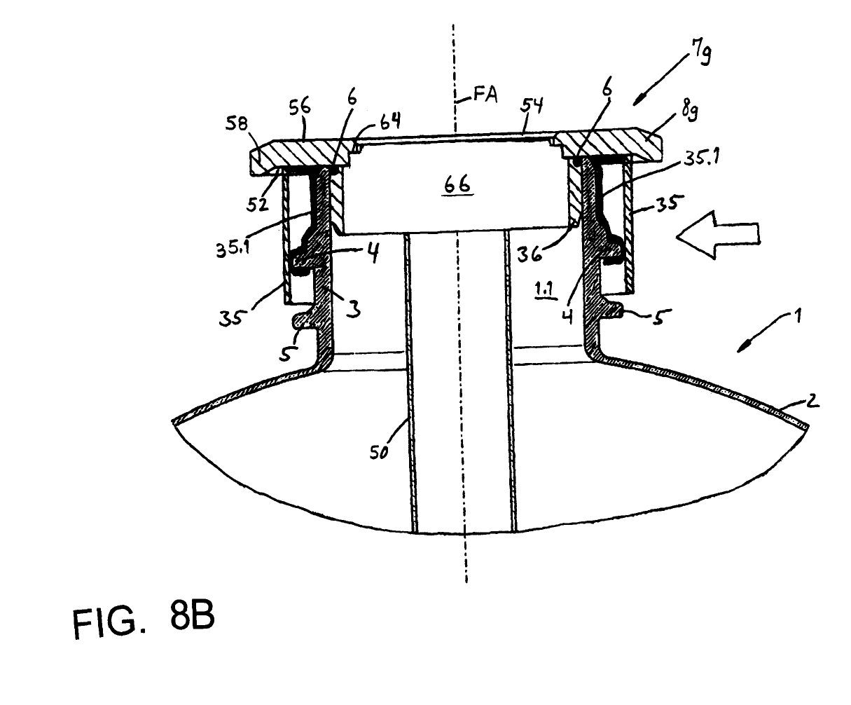

FIG. 8 shows the keg 1 together with a non-returnable fitting 7g which is held outwardly on the keg neck 3 by the permanent or substantially permanent or plastic deformation of an initially tubular or cylindrical wall element 35 which projects beyond the underside of the fitting element 8g.

After the placement of the non-returnable fitting 7g on the keg neck 3, the wall segment 35 is deformed by suitable measures, i.e. with a suitable die and with the realization of the wall element 35 from a thermoplastic material, including with the application of heat, so that the deformed wall element 35.1, which is in contact against the exterior surface of the keg neck 3, forms a positive or form-fit with the contour of the keg neck 3, i.e. among other things it grips the neck ring 4 positively or in a form-fitting manner from behind. Basically it is also possible to manufacture the wall element 25 from shrink film or a material that has properties like those of shrink film, and in one possible embodiment so that the positive or form-fitting contact of the deformed wall element 35.1 following the external contour of the keg neck 3 is achieved as a result of the introduction of heat.

For the required and/or desired seal and in one possible embodiment for the radial protection of the non-returnable fitting 7f on the keg neck 3, the element 8g has an inward, circular cylindrical connecting segment 36 which extends into the keg opening 1.1 and is in contact against the interior surface of this opening. The seal 6 is located between the connecting segment 36 and the interior surface of the keg neck 3 in the vicinity of the mouth opening.

FIG. 8A shows an embodiment of the keg and fitting arrangement of FIG. 8 with additional features and functional elements disclosed. Non-returnable fitting 7g has element 8g. Element 8g has an axial end of wall element 35 secured to disc shaped wall 56. Wall element 35 may be glued or otherwise adhered to surface 52 of disc shaped wall 56 about a circumference 51 thereof. In this embodiment, the heating of wall element 35 causes it to deform as shown as deformed wall element 35.1 wherein the axial end of wall element 35.1 remains secured to surface 52 of disc shaped wall 56 at circumference 51. The portion of wall element 35, proximate disc shaped wall 56, is deformed into deformed wall element 35.1, where it contacts surface 52 of disc-shaped wall 56, keg neck 3, and neck ring 4.

FIG. 8A also shows tube 50 extending from disc-shaped wall 56 for filling and/or dispensing beverages in keg 1. Tube 50 has apertures 60 proximate an end at mouth opening 53. Tube 50 may have an internal valve mechanism for filling and dispensing beverages in keg 1, examples of which are described with reference to FIG. 8B. Mouth opening 53 is defined by lip 62 of tube 50, an outer surface 54 of tube retainer 59, and opening 64 in disc shaped wall 56. Tube retainer 59 holds tube 50 about lip 62 within an internal diameter and is secured within opening 64 about an outer diameter. Also shown in this embodiment, disc shaped wall 56 has an outer angled circumferential portion 58 which may serve to improve handling of the combination of keg 1 and non-returnable fitting 7g.

FIG. 8B shows examples of types of fitting mechanisms 66 that may be used in embodiments of the present invention. For example, U.S. Pat. No. 7,455,082, of which FIGS. 2 and 3 and column 4, lines 17 through 34 are incorporated herein, discloses two types of fittings that have acquired a particular significance. The purpose of incorporating U.S. Pat. No. 7,455,082 is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein. U.S. Pat. No. 7,455,082 discloses flat fittings and basket fittings.

The flat fitting 19, illustrated in FIG. 2 of U.S. Pat. No. 7,455,082, has essentially a plate-shaped or disc-shaped configuration, whereby it contains a movable valve 20 in the shape of a circular ring. This valve 20 is actuated by a hollow cup plunger 21 which enters into a sealed connection with the valve 20 and simultaneously establishes the media connections to the filler tube 22 and the keg interior 23. The procedure is clearly illustrated in FIG. 2, whereby the left half of FIG. 2 shows the closed position and the right half an open position.

The basket fitting 25 illustrated in FIG. 3 of U.S. Pat. No. 7,455,082, has the form of a plurality of circular rings located inside a cylinder, whereby in the middle of these circular rings there is a closing element in the shape of a circular ring. When the basket fitting 25 is used, the circular closing element and the innermost circular ring form the moving valve elements. These elements are raised and actuated by a graduated plunger 26, as a result of which the connections to the keg interior 23 are established.

Another example of a fitting mechanism 66 that may be incorporated into embodiments of the present application is disclosed in U.S. patent application Ser. No. 12/209,407, of which FIG. 1 and page 6, paragraph 3, are incorporated herein. The purpose of incorporating U.S. patent application Ser. No. 12/209,407 is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

For example, in FIG. 1 of U.S. patent application Ser. No. 12/209,407, there is shown a partial illustration of a container (PET keg) in the vicinity of the mouth of the keg, together with a non-reusable fitting provided on the mouth of the keg. FIG. 1 shows a large-volume container which is manufactured by blow molding from a plastic material, e.g. PET, and specifically, for example, in the form of a non-reusable container with a volume of 10 to 20 liters. The container 1 filled with a liquid to be bottled, e.g. mineral water, table water, beer or a similar beverage, is tightly closed by a non-reusable fitting 3 in the vicinity of its top container mouth 2.1 which, as shown in FIG. 1, is formed in the shape of a container neck 2. In the illustrated exemplary embodiment, the fitting 3 the fitting is made of plastic with a fitting valve insert 4 made of stainless steel and is permanently sealed to a flange 2.2 formed on the container neck with the use of a gasket 5 by pressing or locking.

A further example of a fitting mechanism 66 that may be incorporated into embodiments of the present application is disclosed in U.S. patent application Ser. No. 12/359,540, of which FIGS. 1, 1A, 2, 3, 3A, and 3B and page 10, line 202 through page 21, line 424, are incorporated herein. The purpose of incorporating U.S. patent application Ser. No. 12/359,540 is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

For example, U.S. patent application Ser. No. 12/359,540 discloses non-returnable containers 1, in one possible embodiment non-returnable kegs 1. The non-returnable keg 1 in question has a cylindrical surface which is made of an elastic and collapsible plastic of a sufficient material thickness to hold a liquid such as beer, for example. The non-returnable keg 1 can be manufactured by a plastic blow molding process and when filled assumes the shape of an approximately cylindrical pressure bag.

FIG. 1A shows one possible embodiment of a non-returnable keg 1 for use with the present application. The non-returnable keg 1 comprises a brewery-specific keg fitting, tapping head, and/or keg flange 3, an opening 2, and a tube 19, which extends from the keg fitting, keg tapping head and/or keg flange 3 and the opening 2 down into the non-returnable keg 1 to the bottom of the non-returnable keg 1. An opening 2 of the non-returnable keg 1 is equipped with a flange 3 which is visible in FIGS. 2 and 3 and/or a corresponding fitting or tapping head. A control unit or connector 4 which is illustrated in detail in FIG. 3 can be connected with the flange, and in the context of the present application represents a (vacuum) tap or a comparable device. By means of this tap or control unit or connector 4, the food or beverage inside the non-returnable keg 1 can be forced out. For this purpose the control unit or connector 4 has a connector bushing 5 to which a gas source, such as a CO₂ source, for example, can be connected. The interior of the non-returnable keg 1 is pressurized by means of this gas source so that the liquid it houses is discharged from the non-returnable keg 1 via a tube 6 of the control unit or connector 4. For this purpose it is necessary or desired to push down or open a valve 7 on the top of the flange 3 using a lever 8 on the connector piece 4.

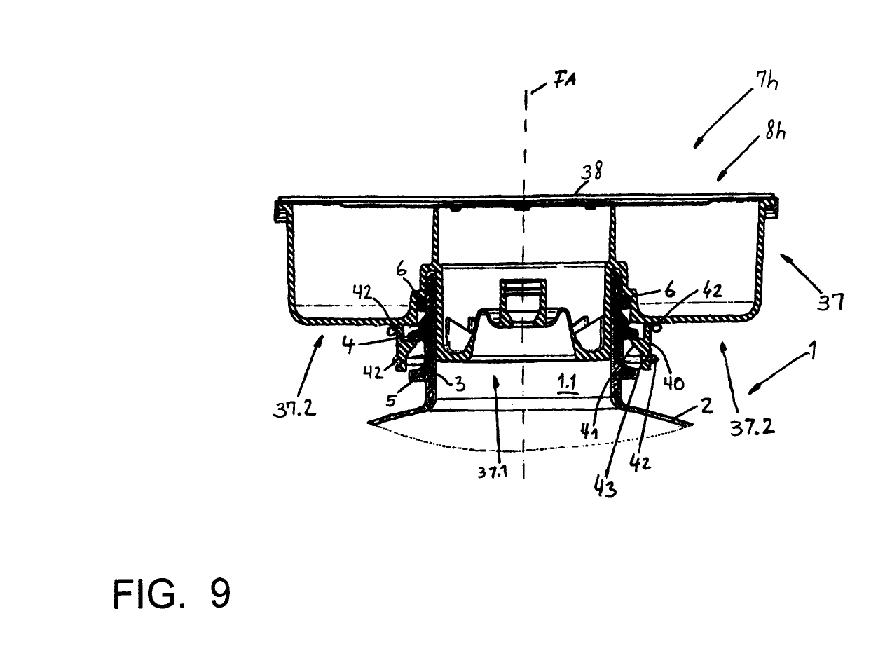

Finally, FIG. 9 shows the keg 1 together with a non-returnable fitting 7h, of which, for purposes of illustration, FIG. 9 shows essentially the fitting element 8h fastened to the keg neck 3. The fitting element 8h essentially comprises a molding made from a suitable material, for example a shell-like housing or bottom part 37 made of plastic, and of a cover 38 that closes this bottom part on the upper side facing away from the keg body. When the non-returnable fitting 7h is installed, the bottom part 37 extends and fits with a central, essentially bowl-shaped segment 37.1 into the keg opening 1. With the external segment 37.2 in the shape of a circular trough that surrounds the axis FA, the bottom part 37 projects radially beyond the external surface of the keg neck 3. The wall of the bottom part 37 is realized at the transition between the inner segment 37.1 and the outer segment 37.2 so that the keg neck 3 is held in an annular opening 39 which is open toward the underside of the bottom part 37. In the vicinity of this opening there is also a seal 6 which seals the transition between the keg neck 3 and the non-returnable fitting 7h on the external surface of the keg neck 3.

The bottom part 37 is also provided in one piece with a connecting segment 40 in the shape of a circular cylinder which projects beyond the underside and encloses the keg neck 3 on its outside in the vicinity of the neck ring 4, and is provide don its interior surface facing the keg neck 3 with an annular projection 41 that forms a catch or lock and which, after the assembly of the non-returnable fitting 7h, grips the neck ring 4 in a positive or form-fitting manner from behind.

On account of the three-dimensional or shell-shaped realization of the bottom part 37, in spite of its thin wall and also in spite of the use of a relatively small quantity of material, and a low weight, the underpart 37 nevertheless has sufficient strength.

To facilitate the locking of the non-returnable fitting 7h on the keg neck 3, it can be possible to divide the annular connecting segment 40 with the catch 41 into segments by slots that run parallel or substantially parallel to the axis FA of the non-returnable fitting 7h. To protect the locked fastening of the non-returnable fitting 7h from unintentionally coming loose, a circlip ring 42 is provided which, after the locking of the fitting element 8h essentially ensures or promotes that the connecting segment 40 or the segments that form the connecting segment 40 are enclosed in a recess 43, which thereby prevents, restricts, and/or minimizes a radial spreading of the connecting segment 40. The snap ring 42 is already installed on the non-returnable fitting 7h when the fitting 7h is installed, and is initially at the transition between the connecting segment 40 and the underside of the bottom part 37. After the locking, the snap ring 42 is pushed down until it is housed in the recess 43.

Suitable materials for the manufacture of the non-returnable fitting 7, 7a-7h include metals, for example, but also in one possible embodiment plastic, whereby in the latter case as many functional elements of the individual non-returnable fitting as possible are made of plastic, for example also the fitting element 8, 8a-8h, which is then in one possible embodiment manufactured as a molding in one piece with the segments for the connection with the keg neck 3.

The present application was explained above with reference to possible embodiments. It goes without saying that numerous modifications and variations can be made without thereby going beyond the teaching of the present application.

For example, in one possible embodiment a heat shrinkable sleeve extends between a flange of the neck of the keg and an upper surface of the fitting. The heat shrinkable sleeve is heated to shrink about the flange and upper surface of the fitting, and possibly even about the lower surface of the flange, thereby holding the fitting onto the keg.

In another possible embodiment, where the fitting is welded onto the keg, an ultrasonic or high frequency plastic welder or sealer may be used. In one embodiment, the fitting may extend into the neck of the keg. In another embodiment, the fitting may extend about an outer perimeter of the neck of the keg. In yet another possible embodiment, the fitting may extend into and about the neck of the keg. An example of a machine that may be used to join the fitting to the keg may be a high frequency plastic welder such as a TB 3, manufactured by Gandus Saldatrici Srl, Via Milano 5. 20010, Cornaredo, Italy.

In one embodiment, a weld may be made by placing several transducer elements about the neck and fitting focusing ultrasonic beams on an area of contact between the neck and fitting. The keg may be then be rotated to make a three hundred sixty degrees weld between the keg and fitting. In another possible embodiment, the fitting may be spot welded, or otherwise welded less than three hundred sixty degrees, to the neck of the keg. In this embodiment of welding less than three hundred sixty degrees, a seal may be made, between the fitting and keg, with a gasket about a connecting segment extending from the fitting and into the neck of the keg.

In yet another possible embodiment, where the fitting is welded to the keg by induction welding, a thin film of metal may be placed between the fitting and keg to generate heat when exposed to a radio frequency electrical current. Alternatively, a portion of the fitting may be made of metal or a portion of the plastic at the areas to be welded may comprise a conductive plastic.

In any of the embodiments of the present invention, the fitting may be comprised of metals, plastics, thermal plastics, or combinations thereof.

According to the present application, the keg fitting is realized in the form of a non-returnable fitting and is held in the mouth area, i.e. on the keg neck which is molded onto the keg body by welding and/or by a positive and/or non-positive connection. A wall segment or tube, which surrounds the keg neck 3, is deformed by the application of heat, for example by the shrink-fitting of the wall segment or tube formed from a shrink film or a material having the properties of a shrink film.

On a keg comprising plastic, in one possible embodiment a keg body made of PET with a keg neck that forms the keg opening and with a keg fitting, the fitting, which is realized in the form of a non-returnable fitting, is non-positively and/or positively held on the keg neck with at least one connecting segment that extends at least partly into the keg neck or at least partly surrounds the keg neck.

One feature or aspect of an embodiment is believed at the time of the filing of this patent application to possibly reside broadly in a keg made essentially of plastic, in one possible embodiment with a keg body 2 fabricated from PET, and a keg fitting 7, 7a-7h on a mouth area 3 that forms a keg opening 1.1, wherein the fitting realized in the form of a non-returnable fitting 7, 7a-7h is held on the mouth area non-positively and/or positively.

Another feature or aspect of an embodiment is believed at the time of the filing of this patent application to possibly reside broadly in the keg, wherein the non-returnable fitting 7, 7a-7h is held on the mouth area 3 non-positively and/or positively with at least one connecting segment 11, 13, 15, 17, 20, 21, 26, 35.1, 40 that extends into the keg opening 1.1 or are least partly surrounds the mouth area 3.

Yet another feature or aspect of an embodiment is believed at the time of the filing of this patent application to possibly reside broadly in the keg, wherein the non-positive connection is produced by barb-like projections or claws 12 on a surface of the non-returnable fitting 7 which is in contact against a surface of the keg body 2, and/or a surface of the keg body 2 which is in contact against a surface of the non-returnable fitting.

Still another feature or aspect of an embodiment is believed at the time of the filing of this patent application to possibly reside broadly in the keg, wherein the non-positive connection is produced by welding, in one possible embodiment induction welding or ultrasound welding.

A further feature or aspect of an embodiment is believed at the time of the filing of this patent application to possibly reside broadly in the keg, wherein the non-positive connection is in the form of an adhesive connection.

Another feature or aspect of an embodiment is believed at the time of the filing of this patent application to possibly reside broadly in the keg, wherein a fitting element 8, 8a-8h that carries additional functional elements of the non-returnable fitting 7, 7a-7h is in one possible embodiment realized in one piece with the connecting segment 11, 13, 15, 17, 20, 21, 26, 40 that extends into the keg mouth 1.1 and/or at least partly surrounds the mouth area.

Yet another feature or aspect of an embodiment is believed at the time of the filing of this patent application to possibly reside broadly in the keg, wherein an annular connecting segment 11 which extends into the keg opening 1.1 and concentrically surrounds a fitting axis FA has the barb-like projections or claws 12 on its exterior surface.

Still another feature or aspect of an embodiment is believed at the time of the filing of this patent application to possibly reside broadly in the keg, wherein the non-returnable fitting 7a, 7b is screwed down to create the positive connection with the keg body or the mouth area 3.

A further feature or aspect of an embodiment is believed at the time of the filing of this patent application to possibly reside broadly in the keg, wherein an annular connecting segment 13 that extends into the keg opening 1.1 is positively connected on its exterior surface by screwing it down to the mouth area 3 of the keg body.

Another feature or aspect of an embodiment is believed at the time of the filing of this patent application to possibly reside broadly in the keg, wherein the non-returnable fitting 7b is positively held on the interior surface of a connecting segment 15 that surrounds and grips the mouth area 3 of the keg body by screwing it down to the mouth area 3 of the keg body.

Yet another feature or aspect of an embodiment is believed at the time of the filing of this patent application to possibly reside broadly in the keg, wherein the non-returnable fitting 7c is positively held on the mouth area 3 of the keg body 2 with the at least one connecting segment 17 in the manner of a bayonet connection.

Still another feature or aspect of an embodiment is believed at the time of the filing of this patent application to possibly reside broadly in the keg, comprising a plurality of connecting segments 17 distributed around the fitting axis, by means of which the non-returnable fitting 7c is held on the keg body 2 in the manner of a bayonet connection.

A further feature or aspect of an embodiment is believed at the time of the filing of this patent application to possibly reside broadly in the keg, wherein the at least one connecting segment is located in front of the exterior surface of the mouth area 3.

One feature or aspect of an embodiment is believed at the time of the filing of this patent application to possibly reside broadly in the keg, wherein the at least one connecting segment has a preferably profiled interlocking surface 18, e.g. realized with locking teeth or claws, which surface 18 is in contact against a mating surface 19 on the keg body 2.

Another feature or aspect of an embodiment is believed at the time of the filing of this patent application to possibly reside broadly in the keg, wherein the mating surface is formed by a projection, for example by a ring segment 19 on the mouth area 3.

Yet another feature or aspect of an embodiment is believed at the time of the filing of this patent application to possibly reside broadly in the keg, wherein the non-positive connection between the at least one connecting segment 21 and the mouth area 3 of the keg body 2 is produced by at least one flexible catch or claw 23.

Still another feature or aspect of an embodiment is believed at the time of the filing of this patent application to possibly reside broadly in the keg, wherein the at least one flexible claw 23 is formed by a spring element which is held or supported on the connecting segment 21 and projects beyond a surface of the connecting segment that is next to the mouth area 3.

A further feature or aspect of an embodiment is believed at the time of the filing of this patent application to possibly reside broadly in the keg, wherein the flexible claw 23 is fabricated from a flat elastic material such as spring steel, for example.

Another feature or aspect of an embodiment is believed at the time of the filing of this patent application to possibly reside broadly in the keg, wherein the non-returnable fitting 7e, 7f, 7h is held on the mouth area 3 of the keg body 2 by a press-fit or a locking fit.

Yet another feature or aspect of an embodiment is believed at the time of the filing of this patent application to possibly reside broadly in the keg, wherein the keg body 2 has, on the mouth area 3, at least one ring or flange 25 that projects beyond the exterior surface and which is gripped from behind by the connecting segment 26.

Still another feature or aspect of an embodiment is believed at the time of the filing of this patent application to possibly reside broadly in the keg, wherein the non-returnable fitting 7 is held with the connecting segment 28 that extends into the keg opening 1.1 in the keg opening 1.1 by locking.

A further feature or aspect of an embodiment is believed at the time of the filing of this patent application to possibly reside broadly in the keg, wherein the non-returnable fitting 7h is held by at least one connecting segment 40 by locking to in on possible embodiment an annular projection 4 that projects beyond the exterior surface of the mouth area 3.

Another feature or aspect of an embodiment is believed at the time of the filing of this patent application to possibly reside broadly in the keg, wherein the non-return fitting 7g is held on the mouth area 3 of the keg body 2 by permanent or substantially permanent or plastic deformation of the connecting segment 35.

Yet another feature or aspect of an embodiment is believed at the time of the filing of this patent application to possibly reside broadly in the keg, wherein the connecting segment 35.1 is deformed from in one possible embodiment a thin-walled wall segment 35 that surrounds the mouth area 3 or from a tube by pressing and/or the application of heat.

Still another feature or aspect of an embodiment is believed at the time of the filing of this patent application to possibly reside broadly in the keg, wherein the tube 35 is formed by a shrink film or a material that has the properties of a shrink film.

A further feature or aspect of an embodiment is believed at the time of the filing of this patent application to possibly reside broadly in the keg, wherein the mouth area 3 of the keg body 2 is held at least over a partial area between an inward connecting segment 20, 36, 37.1 that extends into the keg opening 1.1 and an outer connecting segment 21, 37.2, 35.1 of the non-return fitting 7d, 7g, 7h.

One feature or aspect of an embodiment is believed at the time of the filing of this patent application to possibly reside broadly in the keg, comprising at least one annular seal 6, 32, 33 between the non-returnable fitting 7, 7a-7h and the mouth area 3.

Another feature or aspect of an embodiment is believed at the time of the filing of this patent application to possibly reside broadly in the keg, wherein the at least one seal 6, 32 is provided in the area of a mouth edge of the keg opening 1.1.

Yet another feature or aspect of an embodiment is believed at the time of the filing of this patent application to possibly reside broadly in the keg, wherein the fitting element 8, 8a-8g provided with the connecting segment 11, 13, 15, 17, 21, 26, 28, 35.1 is realized in the form of a plate or disc, in one possible embodiment in the form of a flange that projects beyond the mouth area 3 of the keg body 2.

Still another feature or aspect of an embodiment is believed at the time of the filing of this patent application to possibly reside broadly in the keg, wherein the fitting element 8h held on the mouth area 3 of the keg body 2 is realized in the form of a hollow body, and in one possible embodiment with a segment 37.1 that extends into the keg opening 1.1 and with a segment 37.2 that encloses the mouth area.

A further feature or aspect of an embodiment is believed at the time of the filing of this patent application to possibly reside broadly in the keg, wherein the mouth area is formed by a keg neck 3 in the shape of a hollow cylinder or essentially a hollow cylinder.

Another feature or aspect of an embodiment is believed at the time of the filing of this patent application to possibly reside broadly in the keg, wherein at least the fitting element 8, 8a-8h of the non-returnable fitting 7, 7a-7h that is fastened to the mouth area 3 of the keg body 2 is made out of plastic.

Yet another feature or aspect of an embodiment is believed at the time of the filing of this patent application to possibly reside broadly in a keg comprising essentially a keg body 2 made of plastic, in one possible embodiment of PET, and a keg neck 3 which is realized in the form of a non-returnable keg fitting 7, 7g on a keg opening 1.1 and is manufactured in one piece with the keg body 2, wherein, the keg fitting 7, 7g is non-positively or positively held onto the keg neck 3 by welding or by deformation of a wall segment 35 or tube that surrounds the keg neck 3 under the application of heat.

Still another feature or aspect of an embodiment is believed at the time of the filing of this patent application to possibly reside broadly in the keg, wherein the wall segment 35 or tube that surrounds the keg neck 3 and is deformed under the action of heat is thin-walled.

A further feature or aspect of an embodiment is believed at the time of the filing of this patent application to possibly reside broadly in the keg, wherein the non-returnable fitting 7, 7g is held on the keg neck 3 with at least one connecting segment 11, 35.1 that extends into the keg opening 1.1 or at least partly surrounds the keg neck 3.

Another feature or aspect of an embodiment is believed at the time of the filing of this patent application to possibly reside broadly in the keg, wherein a fitting element 8, 8g that carries additional functional elements of the non-returnable fitting 7, 7g is in one possible embodiment realized in one piece with the connecting segment 11, 35.1 that extends into the keg mouth 1.1 and/or at least partly surrounds the keg neck.

Yet another feature or aspect of an embodiment is believed at the time of the filing of this patent application to possibly reside broadly in the keg, wherein the keg body 2 on the keg neck 3 has at least one ring or flange 5 that projects beyond the outside surface and is gripped from behind by the deformed wall segment 35.1 or tube.

Still another feature or aspect of an embodiment is believed at the time of the filing of this patent application to possibly reside broadly in the keg, wherein the keg neck 3 of the keg body 2 is housed at least over a portion of its area between an inner connecting segment 36 that extends into the keg opening 1.1 and an outer connecting segment 35.1 of the non-returnable fitting 7g.

A further feature or aspect of an embodiment is believed at the time of the filing of this patent application to possibly reside broadly in the keg, comprising at least one annular seal 6 between the non-returnable fitting 7, 7g and the keg neck 3.

One feature or aspect of an embodiment is believed at the time of the filing of this patent application to possibly reside broadly in the keg, wherein the at least one seal 6 is provided in the vicinity of a mouth edge of the keg opening 1.1.

Another feature or aspect of an embodiment is believed at the time of the filing of this patent application to possibly reside broadly in the keg, wherein the fitting element 8, 8g provided with the connecting segment 11, 35.1 is realized in the shape of a plate or disc, in one possible embodiment in the form of a flange that projects beyond the keg neck 3 of the keg body 2.

Yet another feature or aspect of an embodiment is believed at the time of the filing of this patent application to possibly reside broadly in the keg, wherein the keg neck 3 is realized in the form of a hollow cylinder or essentially in the form of a hollow cylinder.

Still another feature or aspect of an embodiment is believed at the time of the filing of this patent application to possibly reside broadly in the keg, wherein at least the fitting element 8, 8g of the non-returnable keg fitting 7, 7g fastened to the keg neck 3 of the keg body 2 is made of plastic.

A further feature or aspect of an embodiment is believed at the time of the filing of this patent application to possibly reside broadly in a method of making a disposable plastic keg with a disposable dispensing tap fitting configured to be connected to a tap, which keg is configured to contain a beverage such as mineral water, table water, beer, or a similar beverage, the method comprising:
a) providing a disposable, one piece, plastic keg comprising:
   a disc shaped first wall enclosing a first end of the keg;
   a second wall comprising a neck axially extending from the first wall, the neck comprising a mouth opening at an axial end opposite the first wall,
   a side wall extending between the first and the second walls;
   the cylindrical neck comprising:
      a first keg flange and a second keg flange disposed on an outer cylindrical surface of the neck, the first keg flange being disposed on the neck a greater axial distance from the side wall than the second keg flange;
      the first keg flange comprising an outer circumference greater than an outer circumference of the neck by an amount sufficient to permit a sleeve to slide over the first keg flange and create a gap between the sleeve and the neck;
      the first keg flange comprising an axial thickness sufficiently large to permit the first keg flange to sufficiently hold the disposable dispensing tap fitting and to seal the disposable dispensing tap fitting onto the neck; and
      the second keg flange being configured to be held during placing the disposable dispensing tap fitting onto the neck and during filling of the disposable keg with the beverage;
b) providing a disposable dispensing tap fitting comprising:
   a disc shaped wall;
   a cylindrical connecting segment axially extending from the disc shaped wall;
   a gasket surrounding an outer circumference of the cylindrical connecting segment;
   a sleeve comprising a first portion with an end attached to the disc shaped top wall, and a second and third portion axially extending from the disc shaped wall, the sleeve surrounding a portion of the connecting segment, the connecting segment and the sleeve having a space therebetween configured to receive a portion of the neck;
   the sleeve comprising an inner diameter greater than an outer diameter of the first keg flange to permit the sleeve to slide over the first keg flange and further comprising an axial length sufficient to grip the first keg flange upon shrinking of the sleeve;
c) inserting the cylindrical connecting segment into the neck;
d) pushing the disposable dispensing tap fitting onto the neck wherein a portion of the neck is received within the space between the connecting segment and the sleeve;
e) sliding the third portion of the sleeve around the first keg flange;
f) sealing the gasket surrounding the cylindrical connecting segment with an inner surface of the neck;
g) heating the first portion of the sleeve;
h) shrinking the first portion of the sleeve in a radial direction and disposing the first portion of the shrunken sleeve to contact the disc shaped wall of the fitting and the neck while maintaining the attached end of the first portion of the sleeve as it was prior to shrinking;
i) heating the second portion of the sleeve;
j) shrinking the second portion of the sleeve in at least a radial direction and disposing the second portion of the sleeve to contact the neck between disc shaped wall of the fitting and the first keg flange;
k) heating the third portion of the sleeve;
l) shrinking the third portion of the sleeve in at least a radial direction and disposing the third portion of the sleeve to contact an upper surface of the first keg flange, an outer circumference of the first keg flange, and a lower surface of the first keg flange, the shrinking of the third portion being sufficient for the shrunken third portion of the sleeve to grip the first keg flange and hold the disposable dispensing tap fitting onto the disposable keg; and
m) maintaining a seal between the gasket on the cylindrical connecting segment and the inner surface of the neck to sufficiently contain the beverage in the disposable plastic keg.

Another feature or aspect of an embodiment is believed at the time of the filing of this patent application to possibly reside broadly in a method of making a disposable plastic keg with a disposable dispensing tap fitting further comprising a step of holding the disposable keg with the second keg flange while conducting the steps of c) through m).

Yet another feature or aspect of an embodiment is believed at the time of the filing of this patent application to possibly reside broadly in a method of making a disposable plastic keg with a disposable dispensing tap fitting, which the first wall, the second wall, and the side wall are comprised of PET.

Still another feature or aspect of an embodiment is believed at the time of the filing of this patent application to possibly reside broadly in a method of making a disposable keg with a disposable dispensing tap fitting, which disposable keg is configured to contain liquids, the method comprising:
a) providing a disposable keg comprising a keg body with an opening structure;
b) providing a disposable dispensing tap fitting configured to seal the opening structure of the keg;
c) disposing the dispensing tap fitting on the keg and disposing a heat shrinkable sleeve about the opening structure of the keg;
d) heating the heat shrinkable sleeve;
e) shrinking the heat shrinkable sleeve; and
f) holding and sealing the dispensing tap fitting on the opening structure of the keg to permit sealing of the liquids of the disposable keg.

A further feature or aspect of an embodiment is believed at the time of the filing of this patent application to possibly reside broadly in a method of making a disposable keg with a disposable dispensing tap fitting, which the disposable keg body comprises PET.

Another feature or aspect of an embodiment is believed at the time of the filing of this patent application to possibly reside broadly in a method of making a disposable keg with a disposable dispensing tap fitting, which the heat shrinkable sleeve is placed about a portion of the disposable dispensing tap prior to the step of disposing the dispensing tap fitting on the keg and disposing a heat shrinkable sleeve about the opening structure of the keg.

Yet another feature or aspect of an embodiment is believed at the time of the filing of this patent application to possibly reside broadly in a method of making a disposable keg with a disposable dispensing tap fitting, which the heat shrinkable sleeve comprises a shrink film.

One feature or aspect of an embodiment is believed at the time of the filing of this patent application to possibly reside broadly in a method of making a disposable keg with a disposable dispensing tap fitting, which the disposable dispensing tap fitting has a connecting segment configured to extend into the opening structure of the keg; the method further comprising the step of extending the connecting segment into the opening structure of the keg.

Another feature or aspect of an embodiment is believed at the time of the filing of this patent application to possibly reside broadly in a method of making a disposable keg with a disposable dispensing tap fitting, which the connecting segment has a seal on a perimeter thereof configured to seal between the disposable dispensing tap fitting and the opening structure of the disposable keg.

Yet another feature or aspect of an embodiment is believed at the time of the filing of this patent application to possibly reside broadly in a method of making a disposable keg with a disposable dispensing tap fitting, which the disposable dispensing tap fitting or the disposable keg has barb-like projections or claws on a surface thereof configured to contact a mating surface of the other of the disposable dispensing tap fitting or the disposable keg, the method further comprising a step of contacting the barb-like projections or claws with the mating surface.

Still another feature or aspect of an embodiment is believed at the time of the filing of this patent application to possibly reside broadly in a method of making a disposable keg with a disposable dispensing tap fitting, which the disposable dispensing tap fitting has barb-like projections or claws on a surface thereof configured to contact a mating surface of the disposable keg, the method further comprising a step of contacting the barb-like projections or claws on the disposable tap fitting with the mating surface of the keg.

A further feature or aspect of an embodiment is believed at the time of the filing of this patent application to possibly reside broadly in a method of making a disposable keg with a disposable dispensing tap fitting, which the opening structure of the keg has at least one ring or flange that projects beyond an outside surface thereof configured to be gripped by the heat shrinkable sleeve, the method further comprising a step of gripping the at least one ring or flange with the heat shrinkable sleeve.

Another feature or aspect of an embodiment is believed at the time of the filing of this patent application to possibly reside broadly in a method of making a disposable keg with a disposable dispensing tap fitting, which the connecting segment and the heat shrinkable sleeve have a space therebetween configured to receive a portion of the opening structure of the disposable keg, the method further comprising a step of receiving a portion of the opening structure of the keg between the connecting segment and the heat shrinkable sleeve.

Yet another feature or aspect of an embodiment is believed at the time of the filing of this patent application to possibly reside broadly in a method of making a disposable keg with a disposable dispensing tap fitting, which the disposable keg or the disposable dispensing tap fitting have a seal configured to seal the dispensing tap fitting on the opening structure of the keg.

Still another feature or aspect of an embodiment is believed at the time of the filing of this patent application to possibly reside broadly in a method of making a disposable keg with a disposable dispensing tap fitting, which the dispensing tap fitting has at least a portion contacting the disposable keg made of plastic.

A further feature or aspect of an embodiment is believed at the time of the filing of this patent application to possibly reside broadly in a method of making a disposable keg with a disposable dispensing tap fitting, which the keg body is in the form of a hollow cylinder.

Another feature or aspect of an embodiment is believed at the time of the filing of this patent application to possibly reside broadly in a method of making a disposable keg with a disposable dispensing tap fitting, which disposable keg is configured to contain liquids, the method comprising:
a) providing a disposable keg comprising a keg body with an opening structure;
b) providing a disposable dispensing tap fitting configured to seal the opening structure of the keg;
c) disposing the dispensing tap fitting on the keg;
d) welding the dispensing tap fitting to the keg; and
e) holding and sealing the dispensing tap fitting on the opening structure of the keg to permit sealing of the liquids of the disposable keg.

Yet another feature or aspect of an embodiment is believed at the time of the filing of this patent application to possibly reside broadly in a method of making a disposable keg with a disposable dispensing tap fitting, which step of welding of the dispensing tap fitting to the keg is performed by induction welding or ultrasound welding.

One feature or aspect of an embodiment is believed at the time of the filing of this patent application to possibly reside broadly in a method of making a disposable keg with a disposable dispensing tap fitting, which portions of the disposable keg and disposable dispensing tap fittings welded together in the step of welding the dispensing tap fitting to the keg, are comprised of PET.

Another feature or aspect of an embodiment is believed at the time of the filing of this patent application to possibly reside broadly in a method of making a disposable keg with a disposable dispensing tap fitting, which the disposable keg or the disposable dispensing tap fitting have a seal configured to seal the dispensing tap fitting on the opening structure of the keg.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, which were cited in the International Search Report dated Jun. 24, 2008, and/or cited elsewhere are hereby incorporated by reference as if set forth in their entirety herein as follows: GB 851 855, having the title “IMPROVEMENTS IN OR RELATING TO CONTAINERS SUCH AS BARRELS,” published on Oct. 19, 1960; EP 0 102 701, having the title “CLOSURE-FITTING UNIT FOR BEVERAGE CONTAINERS,” published on Mar. 14, 1984; DE 100 09 895, having the following English translation of the German title “STOPPER CONSISTS OF PLASTIC PART WITH COVERING WALL, SURGE-PROOF WALL, DEGASSING VENT, FILTER FLEECE, RIDGE, STOPPER FRAME AND SEALING RING,” published on Sep. 20, 2001; and U.S. Pat. No. 3,670,915, having the title “MULTI-PURPOSE STOPPER,” published on Jun. 20, 1972.

All of the patents, patent applications or patent publications, which were cited in the German Office Action dated Feb. 27, 2008, and/or cited elsewhere are hereby incorporated by reference as if set forth in their entirety herein as follows: DE 101 38 365, having the following English translation of the German title “DISPOSABLE KEG FOR ACCOMMODATION OF LIQUID FOOD PRODUCTS, IN PARTICULAR BEER, COMPRISES WELD SEAMS WHICH JOIN INDIVIDUAL KEG SECTIONS, AND ARE DISTANCED FROM THE KEG INTERIOR,” published on Feb. 20, 2003; DE 91 01 698, published on Jul. 4, 1991; DE 10 2006 026 279, having the German title “VERFAHREN SOWIE VORRICHTUNG ZUM HERSTELLEN VON VERPACKUNGSEINHEITEN ODER GEBINDEN,” published on Dec. 6, 2007; DE 35 33 241, having the following English translation of the German title “CONNECTING AND SEALING DEVICE FOR A BAG CONTAINING LIQUID (BAG-IN-BOX) WHICH HAS A BUNG WHICH IS ESPECIALLY EXTRUDED FROM PLASTIC,” published on May 7, 1987; DE 202 21 421, having the following German title “VENTILANORDNUNG ZUR VERWENDUNG BEIM ZAPFEN VON EINEM GETRÄNK,” published on Oct. 20, 2005; DE 36 14 488, having the German title “ZAPFGERAET FUER EINEN FLUESSIGKEITSBEHAELTER,” published on Nov. 6, 1986; and DE 42 31 635, having the following English translation of the German title “CONTAINER FOR STORING AND TRANSPORTING POURABLE MEDIA, PREFERABLY LIQUIDS,” published on Mar. 24, 1994.

Some examples of shrink wrapping materials and machines that may possibly be utilized or adapted for use in at least one possible embodiment may possibly be found in the following U.S. patents: U.S. Pat. No. 6,826,893, entitled “Apparatus for wrapping products with plastic film;” U.S. Pat. No. 6,739,115, entitled “Equipment for wrapping groups of products in plastic film;” U.S. Pat. No. 5,878,555, entitled “Apparatus for wrapping articles in plastic film;” U.S. Pat. No. 5,787,691, entitled “Apparatus for wrapping articles in plastic film;” U.S. Pat. No. 5,519,983, entitled “Shrink wrap packaging system with an ultrasonic side sealer;” U.S. Pat. No. 4,956,963, entitled “Method of sealing a shrink wrap package;” U.S. Pat. No. 4,873,814, entitled “Method of making a shrink wrap package;” and U.S. Pat. No. 4,214,419, entitled “Collating and shrink wrap packaging apparatus;” U.S. Pat. No. 6,484,475, entitled “Modular packaging machine;” U.S. Pat. No. 4,694,633, entitled “Film wrapping machine;” U.S. Pat. No. 4,118,916, entitled “Thermoplastic wrapping machine;” U.S. Pat. No. 4,118,916, entitled “Thermoplastic wrapping machine;” U.S. Pat. No. 5,371,999, entitled “Shrink film wrapping machine;” U.S. Pat. No. 4,748,795, entitled “Film wrapping machine;” and U.S. Pat. No. 5,115,620, entitled “Wrapping machine.”

Some examples of conductive plastic that may possibly be utilized or adapted for use in at least one possible embodiment may possibly be found in the following U.S. patents: U.S. Pat. No. 4,216,351, entitled “Plastic collar integral with a cable jacket; and U.S. Pat. No. 4,581,158, entitled, “Conductive thermosetting compositions and process for using same”.

Some examples of induction welding that may possibly be utilized or adapted for use in at least one possible embodiment may possibly be found in the following U.S. patents: U.S. Pat. No. 3,996,402, entitled “Fastening device for use with induction heater apparatus and system for holding together two nonmetal surfaces”; and U.S. Pat. No. 4,947,462, entitled, “Induction welding apparatus and method”.

Some examples of ultrasonic welding that may possibly be utilized or adapted for use in at least one possible embodiment may possibly be found in the following U.S. patents: U.S. patent publication 20070158011, entitled “Ultrasonic welding structure and ultrasonic welding method”; U.S. Pat. No. 5,520,775, entitled, “Energy director for ultrasonic weld joint”; and U.S. Pat. No. 7,523,849, entitled, “Ultrasonic welding method, ultrasonic welding device and pipe joined by the same”.

Some examples of applications of heat shrinkable materials that may possibly be utilized or adapted for use in at least one possible embodiment may possibly be found in the following U.S. patents: U.S. Pat. No. 7,273,146, entitled, “Container whose side wall includes a surface discontinuity to hold shrinkwrap thereto”; U.S. Pat. No. 5,992,630, entitled, “Shrink wrap package”; and U.S. Pat. No. 3,739,544, entitled, “METHOD AND APPARATUS FOR THE SHRINK-WRAPPING OF PACKAGES”.

The patents, patent applications, and patent publication listed above in the preceding seven paragraphs are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 061 120.9, filed on Dec. 22, 2006, having inventors Thomas BERGER, Gerhard KUNZ, Christian BÖLSCHER, Thorsten SCHMIDT, Robert DAVID, and Jürgen LANDAUER, and DE-OS 10 2006 061 120.9 and DE-PS 10 2006 061 120.9, and International Application No. PCT/EP2007/009692, filed on Nov. 8, 2007, having WIPO Publication No. WO 2008/083782 and inventors Thomas BERGER, Gerhard KUNZ, Christian BÖLSCHER, Thorsten SCHMIDT, Robert DAVID, and Jürgen LANDAUER, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the corresponding foreign equivalent patent application(s), that is, PCT/EP2007/009692 and German Patent Application 10 2006 061 120.9, is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/009692 and DE 10 2006 061 120.9 from which this patent application claims priority which do not have to do with the correction of the translation in this patent application are not to be included in this patent application in the incorporation by reference.

Any statements about admissions of prior art in the original foreign patent applications PCT/EP2007/009692 and DE 10 2006 061 120.9 are not to be included in this patent application in the incorporation by reference, since the laws relating to prior art in non-U.S. Patent Offices and courts may be substantially different from the Patent Laws of the United States.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.

Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### PARTIAL LIST OF NOMENCLATURE

1 Keg
1.1 Keg opening
2 Keg body
3 Keg neck
4, 5 Neck ring
6 Seal
7, 7a-7h Non-returnable fitting
8, 8a-8h Cap of fitting element
9, 10 Fitting element
11 Connecting segment
12 Projection
13 Connecting segment
14 Female thread
15 Connecting segment
16 Male thread
17 Connecting segment
18 Interlocking surface
19 Neck ring surface
20, 21 Connecting segment
21.1 Recess
22 Seal
23 Claw
24 Opening
25 Neck segment
26-28 Connecting segment
29 Annular projection
30 Groove
31 Conical area
32, 33 Sealing ring
34 Projection
35 Wall element
35.1 Deformed wall element
36 Connecting segment
37 Bottom part
37.1, 37.2 Segment of the bottom part
38 Cover
39 Opening
40 Connecting segment
41 Catch
42 Snap ring
43 Recess for snap ring
FA Fitting axis

What is claimed is:

1. A method of making a disposable plastic keg with a disposable dispensing tap fitting configured to be connected to a tap, which keg is configured to contain a beverage such as mineral water, table water, beer, or a similar beverage, said method comprising:
a) providing a disposable, one piece, plastic keg comprising:
a disc shaped first wall enclosing a first end of said keg;
a second wall comprising a neck axially extending from said first wall, said neck comprising a mouth opening at an axial end opposite said first wall,
a side wall extending between said first and said second walls;
said cylindrical neck comprising:
a first keg flange and a second keg flange disposed on an outer cylindrical surface of said neck, said first keg flange being disposed on said neck a greater axial distance from said side wall than said second keg flange;
said first keg flange comprising an outer circumference greater than an outer circumference of said neck by an amount sufficient to permit a sleeve to slide over said first keg flange and create a gap between said sleeve and said neck;
said first keg flange comprising an axial thickness sufficiently large to permit said first keg flange to sufficiently hold said disposable dispensing tap fitting and to seal said disposable dispensing tap fitting onto said neck; and
said second keg flange being configured to be held during placing said disposable dispensing tap fitting onto said neck and during filling of said disposable keg with said beverage;
b) providing a disposable dispensing tap fitting comprising:
a disc shaped wall;
a cylindrical connecting segment axially extending from said disc shaped wall;
a gasket surrounding an outer circumference of said cylindrical connecting segment;
a sleeve comprising a first portion with an end attached to said disc shaped top wall, and a second and third portion axially extending from said disc shaped wall, said sleeve surrounding a portion of said connecting segment, said connecting segment and said sleeve having a space therebetween configured to receive a portion of said neck;
said sleeve comprising an inner diameter greater than an outer diameter of said first keg flange to permit said sleeve to slide over said first keg flange and further comprising an axial length sufficient to grip said first keg flange upon shrinking of said sleeve;
c) inserting said cylindrical connecting segment into said neck;
d) pushing said disposable dispensing tap fitting onto said neck wherein a portion of said neck is received within said space between said connecting segment and said sleeve;
e) sliding said third portion of said sleeve around said first keg flange;
f) sealing said gasket surrounding said cylindrical connecting segment with an inner surface of said neck;
g) heating said first portion of said sleeve;
h) shrinking said first portion of said sleeve in a radial direction and disposing said first portion of said shrunken sleeve to contact said disc shaped wall of said fitting and said neck while maintaining the attached end of said first portion of said sleeve as it was prior to shrinking;
i) heating said second portion of said sleeve;
j) shrinking said second portion of said sleeve in at least a radial direction and disposing said second portion of said sleeve to contact said neck between disc shaped wall of said fitting and said first keg flange;
k) heating said third portion of said sleeve;
l) shrinking said third portion of said sleeve in at least a radial direction and disposing said third portion of said sleeve to contact an upper surface of said first keg flange, an outer circumference of said first keg flange, and a lower surface of said first keg flange, said shrinking of said third portion being sufficient for said shrunken third portion of said sleeve to grip said first keg flange and hold said disposable dispensing tap fitting onto said disposable keg; and
m) maintaining a seal between said gasket on said cylindrical connecting segment and said inner surface of said neck to sufficiently contain said beverage in said disposable plastic keg.

2. The method of making a disposable plastic keg with a disposable dispensing tap fitting of claim 1, further comprising a step of holding said disposable keg with said second keg flange while conducting said steps of c) through m).

3. The method of making a disposable plastic keg with a disposable dispensing tap fitting of claim 2, which said first wall, said second wall, and said side wall are comprised of PET.

4. A method of making a disposable keg with a disposable dispensing tap fitting, which disposable keg is configured to contain liquids, said method comprising:
a) providing a disposable keg comprising a keg body with an opening structure;
b) providing a disposable dispensing tap fitting configured to seal said opening structure of said keg;
c) disposing said dispensing tap fitting on said keg and disposing a heat shrinkable sleeve about said opening structure of said keg;
d) heating said heat shrinkable sleeve;
e) shrinking said heat shrinkable sleeve; and
f) holding and sealing said dispensing tap fitting on said opening structure of said keg to permit sealing of said liquids of said disposable keg.

5. The method of making a disposable keg with a disposable dispensing tap fitting of claim 4, which said disposable keg body comprises PET.

6. The method of making a disposable keg with a disposable dispensing tap fitting of claim 4, which said heat shrinkable sleeve is placed about a portion of said disposable dispensing tap prior to said step of disposing said dispensing tap fitting on said keg and disposing a heat shrinkable sleeve about said opening structure of said keg.

7. The method of making a disposable keg with a disposable dispensing tap fitting of claim 6, which said heat shrinkable sleeve comprises a shrink film.

8. The method of making a disposable keg with a disposable dispensing tap fitting of claim 4, which said disposable dispensing tap fitting has a connecting segment configured to extend into said opening structure of said keg; said method further comprising the step of extending said connecting segment into said opening structure of said keg.

9. The method of making a disposable keg with a disposable dispensing tap fitting of claim 8, which said connecting segment has a seal on a perimeter thereof configured to seal between said disposable dispensing tap fitting and said opening structure of said disposable keg.

10. The method of making a disposable keg with a disposable dispensing tap fitting of claim 4, which said disposable dispensing tap fitting or said disposable keg has barb-like projections or claws on a surface thereof configured to contact a mating surface of the other of said disposable dispensing tap fitting or said disposable keg, said method further comprising a step of contacting said barb-like projections or claws with said mating surface.

11. The method of making a disposable keg with a disposable dispensing tap fitting of claim 10, which said disposable dispensing tap fitting has barb-like projections or claws on a surface thereof configured to contact a mating surface of said disposable keg, said method further comprising a step of contacting said barb-like projections or claws on said disposable tap fitting with said mating surface of said keg.

12. The method of making a disposable keg with a disposable dispensing tap fitting of claim 4, which said opening structure of said keg has at least one ring or flange that projects beyond an outside surface thereof configured to be gripped by said heat shrinkable sleeve, said method further comprising a step of gripping said at least one ring or flange with said heat shrinkable sleeve.

13. The method of making a disposable keg with a disposable dispensing tap fitting of claim 8, which said connecting segment and said heat shrinkable sleeve have a space therebetween configured to receive a portion of said opening structure of said disposable keg, said method further comprising a step of receiving a portion of said opening structure of said keg between said connecting segment and said heat shrinkable sleeve.

14. The method of making a disposable keg with a disposable dispensing tap fitting of claim 4, which said disposable keg or said disposable dispensing tap fitting have a seal configured to seal said dispensing tap fitting on said opening structure of said keg.

15. The method of making a disposable keg with a disposable dispensing tap fitting of claim 4, which said dispensing tap fitting has at least a portion contacting said disposable keg made of plastic.

16. The method of making a disposable keg with a disposable dispensing tap fitting of claim 4, which said keg body is in the form of a hollow cylinder.

17. A method of making a disposable keg with a disposable dispensing tap fitting, which disposable keg is configured to contain liquids, said method comprising:
a) providing a disposable keg comprising a keg body with an opening structure;
b) providing a disposable dispensing tap fitting configured to seal said opening structure of said keg;
c) disposing said dispensing tap fitting on said keg;
d) welding said dispensing tap fitting to said keg; and
e) holding and sealing said dispensing tap fitting on said opening structure of said keg to permit sealing of said liquids of said disposable keg.

18. The method of making a disposable keg with a disposable dispensing tap fitting of claim 17, which step of welding of said dispensing tap fitting to said keg is performed by induction welding or ultrasound welding.

19. The method of making a disposable keg with a disposable dispensing tap fitting of claim 18, which portions of said disposable keg and disposable dispensing tap fittings welded together in said step of welding said dispensing tap fitting to said keg, are comprised of PET.

20. The method of making a disposable keg with a disposable dispensing tap fitting of claim 19, which said disposable keg or said disposable dispensing tap fitting have a seal configured to seal said dispensing tap fitting on said opening structure of said keg.
